(19) United States
(12) Patent Application Publication
(10) Pub. No.: US 2009/0102777 A1
(43) Pub. Date: Apr. 23, 2009

(54) Method for driving liquid crystal display panel with triple gate arrangement

(75) Inventors: Masaki Izumikawa, Kanagawa (JP); Masayuki Kumeta, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/285,985

(22) Filed: Oct. 17, 2008

(30) Foreign Application Priority Data
Oct. 19, 2007 (JP) 2007-273085

(51) Int. Cl. G09G 3/36; G02F 1/133

(52) U.S. Cl. 345/96; 349/37

(57) ABSTRACT

A method is provided for driving a liquid crystal display panel in which each pixel includes a plurality of sub-pixels arranged in a specific direction, the method including feeding drive voltages to sub-pixels within the liquid crystal display panel by using operational amplifiers. The polarities of the drive voltages fed to each of the sub-pixels are inverted between two adjacent frame periods. The offset polarities of the operational amplifiers are inverted for every a predetermined number of successive sub-pixels. The number of the sub-pixels within each pixel is coprime to the predetermined number of successive sub-pixels.

This application claims the benefit of priority based on Japanese Patent Application No. 2007-273085, filed on Oct. 19, 2007, the disclosure of which is incorporated herein by reference.

### BACKGROUND OF THE INVENTION

1. Field of the Invention

The present invention relates to a method of driving an LCD (liquid crystal display) panel, more specifically, to a technique for driving an LCD panel in which each pixel incorporates multiple sub-pixels.

2. Description of the Related Art

A typical color liquid crystal display device includes a plurality of pixels regularly arranged in rows and columns. The color liquid crystal display device displays a desired image with various colors of desired hue, brightness, and chroma by controlling the transmittance and/or reflectance of sub-pixels within each pixel. In a typical LCD panel, each pixel includes three sub-pixels associated with three primary colors of light, respectively. In the following, a description is given of a color liquid crystal display device in which each pixel includes an R, G and B sub-pixels, which are associated with red, green and blue, respectively.

In a typical liquid crystal display device, light emitted from the backlight transmits through liquid crystal within respective sub-pixels and a color filter. The intensity of transmitted light from the backlight depends on the transmittance of the liquid crystal, and the transmittance of the liquid crystal depends on the drive voltage applied to the liquid crystal. The drive voltage applied to the liquid crystal is controlled by a source driver (or drain driver) which drives signal lines of the liquid crystal display panel, for example.

Each sub-pixel incorporates a TFT (thin film transistor), and the TFTs are arranged in rows and columns over the liquid crystal display panel. The gates electrodes of TFTs arranged laterally in a row are commonly connected to a single lead line. Similarly, the source electrodes of TFTs arranged vertically in a column are commonly connected to a single lead line. In general, a lead line connected to gate electrodes is referred to as a gate line or a scan line. Similarly, a lead line connected to source electrodes is referred to as a source line or a signal line. The drain electrodes of the TFTs are each connected to a pixel electrode which is opposed a common electrode through a liquid crystal capacitance formed of liquid crystal filled between the pixel electrode and the common electrode. It should be noted the connections of the source and drain electrodes may be interchanged in accordance with the polarity of TFTs within the LCD panel.

The signal lines are arranged in parallel to each other, and the scan lines are also arranged in parallel to each other. The signal lines and the scan lines orthogonally cross with one another, and one sub-pixel, that is, one TFT is disposed at each intersection of the signal lines and scan lines.

The scan lines are sequentially driven by one or more gate drivers. In usual operation, only one scan line is driven at the same time. On the other hand, the signal lines are driven by one or more source drivers, and the signal lines are simultaneously driven to desired voltage levels. That is, the sub-pixels connected to a certain scan line are subjected to the changes of the transmittance of the liquid crystal at the same time with the source and gate electrodes driven by the gate and source drivers.

When the gate driver(s) drives a selected scan line, the TFTs connected to the selected line are turned on, and the source driver(s) simultaneously drives the signal lines to desired voltage level. Drive voltages supplied from the source driver are fed to the liquid crystal capacitances within the respective sub-pixels through the TFTs connected to the signal lines. In this way, the transmittance of the liquid crystal within each sub-pixel associated with the selected scan line is controlled to achieve desired brightness of the each sub-pixel.

In the following, a description is given of the arrangement of three sub-pixels within each pixel. As is known in the art, the arrangement in which three sub-pixels are arranged along a signal line within each pixel effectively reduces the manufacture cost of a liquid crystal display device. Such arrangement is referred to as the triple gate arrangement, hereinafter. The triple gate arrangement effectively reduces the number of signal lines to one third for one liquid crystal display device, although the number of scan lines is increased by three times. The reduction in the number of signal lines allows reducing the cost for the source driver(s) and thereby reducing the cost of the whole liquid crystal display device, although the cost of the gate drive(s) is increased.

FIG. 1 is a block diagram illustrating an exemplary arrangement of sub-pixels within a liquid crystal display panel. The numbers arranged in the left-most column are associated with respective scan lines, and the numbers arranged in the top-most row are associated with respective signal lines. The solid lines indicate the boundaries of the pixels and the broken lines indicate the boundaries of sub-pixels within each pixel. Within each pixel, R, G and B sub-pixels are arranged in the vertical direction with the scan lines extended in the horizontal direction.

FIG. 2 is a circuit diagram of a pixel within a liquid crystal display panel with triple gate arrangement. Gate liens G1 to G4 are horizontally arranged in parallel and the signal lines S1 and S2 are vertically arranged in parallel. The drain electrodes of the three transistors are connected to the R, G and B sub-pixels, respectively. The gate electrodes of these transistors T are connected to the scan lines G1 to G3, respectively. The source electrodes of the transistors T are connected to the signal line S1.

FIG. 3 is a block diagram illustrating an exemplary configuration of the liquid crystal display device. In this liquid crystal display device, a source driver and gate driver are monolithically integrated within a single semiconductor chip. Such configuration is preferably used for a mobile device, such as cellular phones.

Japanese Laid Open Patent Application No. JP-A-Heisei 10-228263 discloses a liquid crystal display device in which each pixel incorporates three sub-pixels arranged along the same signal line. In this liquid crystal display device, each frame period is divided into a plurality of fields. The number of fields within each frame is equal to or more than the number of primary colors of the liquid crystal display device. In scanning the scan lines in each field, one scan line is driven for every predetermined number of scan lines, skipping the remaining scan lines. In each field; the ratios of the number of scan lines to be driven for the respective primary colors are fixed. It should be noted that this drive technique, which involves scan line skipping in scanning the scan lines, is not common in driving a liquid crystal display panel.

Another common technique for driving a liquid crystal display panel is the inversion drive, which effectively avoids the “burn-in” effect and also reduces the power consumption. In general, continuous feeding of a DC voltage to liquid crystal undesirably causes the “burn-in” of the liquid crystal display. One known approach for avoiding the “burn-in” is to regularly invert the polarity of the drive voltage applied to the liquid crystal, that is, to invert the polarity of the voltage applied between the pixel electrode and the common electrode, between which liquid crystal is filled.

One known inversion drive technique is the “dot” inversion drive. FIG. 4 schematically illustrates the dot inversion drive technique. In FIG. 4, each box represents an R, G, or B sub-pixel. Further, the symbol “+” or “−” in each box indicates the polarity of the drive voltage applied to the sub-pixel corresponding to the box. The symbols “+” indicate the positive polarity, and the symbols “−” indicated the negative polarity. In the arrangement of FIG. 4, each pixel incorporates R, G, and B sub-pixels arranged in the horizontal direction (that is, the direction of the scan line); the triple gate arrangement described above is not employed.

As shown in FIG. 4, the dot inversion drive involves applying drive voltages of opposite polarities to every two adjacent sub-pixels for both of the vertical and horizontal directions. Preferably, the polarity of the drive voltage in m-th frame period is opposite to that in the next “m+1”-th frame period for every sub-pixel. In the dot inversion drive, the polarities of the drive voltages applied to the signal lines is switched between positive and negative for every two adjacent sub-pixels during the activation of the selected scan line, while the voltage level of the common electrode is kept constant. This achieves applying a positive or negative voltage to each sub-pixel with respect to the common electrode voltage.

Another known inversion drive technique is the column inversion technique. FIG. 5 schematically illustrates the column inversion technique. As is the case of FIG. 4, each box represents an R, G, or B sub-pixel in FIG. 5. Further, the symbols “+” and “−” in the respective boxes indicate the polarities of the drive voltages applied to the sub-pixels, respectively.

As shown in FIG. 5, the column inversion drive involves applying drive voltages of the same polarity to every two sub-pixels adjacent in the vertical direction, while applying drive voltages of the opposite polarities to every two sub-pixels adjacent in the horizontal direction. Preferably, the polarity of the drive voltage in m-th frame period is inverted in the next “m+1”-th frame period for each sub-pixel.

Comparing the dot inversion drive and the column inversion drive, the dot inversion provides a better picture quality, while the column inversion drive effectively reduces the power consumption.

It should be noted that both of the triple gate arrangement and the dot inversion drive can be simultaneously applied to one liquid crystal display device. In the same way, both of the triple gate arrangement and the column inversion drive can be simultaneously applied to one liquid crystal display device.

The dot inversion drive and column inversion drive are disclosed in Japanese Laid-Open Patent Application No. JP 2005-345770A, for example. The LCD panel drive method disclosed in this application is directed to a liquid crystal display device in which the liquid crystal display panel includes first and second data line sets each including an even number of data lines with the common electrode voltage kept constant. The liquid crystal display panel drive method includes steps of: (a) time-divisionally selecting the data lines for each of the first and second data line sets; and (b) sequentially supplying data signals to the selected data lines to write the data signals onto the corresponding pixels. The order of selecting the data lines and the polarities of the data signals written onto the respective pixels are determined so that the polarity of the data signal supplied to the data line selected from the first data line set is opposite to that of the data signal supplied to the data line selected from the second data line set.

Another commonly-used technique in driving a liquid crystal display panel is the offset cancel operation. The source driver incorporates operational amplifiers which drives the signal lines to supply desired drive voltages to the respective sub-pixels. One issue is that commercially available operational amplifiers undesirably suffer from output voltage offset; the actual output voltage of the operational amplifier is different from the desired output voltage due to the voltage offset. The offset in the output voltage of an operation amplifier undesirably causes errors in the brightnesses of the corresponding sub-pixels, since the operational amplifier output voltage applied to the liquid crystal within each sub-pixel corresponds to the brightness of the each sub-pixel.

Undesirably, a plurality of operational amplifiers often exhibit different intrinsic offset voltages. That is, there are variations in the offset voltages of the operation amplifiers within the source driver for a single liquid crystal display panel. The variations in the offset voltages of the operational amplifiers impose an undesired influence on the picture quality of the liquid crystal display device.

Such influence is commonly imposed on all the sub-pixels connected to the same signal line, and this may lead to color unevenness conceived as a conspicuous stripe extending from one edge of the liquid crystal display panel to the other edge or a portion thereof. This largely deteriorates the picture quality of the liquid crystal display panel. This problem is referred to as “striped color unevenness”, hereinafter. As described below, the striped color unevenness also occurs in displaying a checkered pattern on the liquid crystal display panel, as is known in the art.

In the following, a discussion is given of effects of the offset voltage of the operational amplifier. When the polarity of the desired output voltage of the operational amplifier is the same as that of the offset voltage, the absolute value of the resultant output voltage of the operational amplifier is increased above the desired value. Therefore, the brightness of the corresponding sub-pixel is increased above the desired value. When the polarity of the desired output voltage of the operational amplifier is opposite to that of the offset voltage, on the other hand, the absolute value of the output voltage of the operational amplifier is decreased below the desired value. Therefore, the brightness of the corresponding sub-pixel is decreased below the desired value. As described above, the influence of the offset voltage imposed upon the brightness of the sub-pixel may be opposite depending on the polarity of the desired output voltage of the operational amplifier.

In order to reduce the influence of the offset voltage of the operational amplifier upon the brightness of sub-pixels, it would be desirable that sub-pixels exhibiting brightnesses higher than the desired levels and sub-pixels exhibiting brightnesses lower than the desired levels are located mixedly in the spatial domain. This operation is referred to as the spatial offset cancel operation, hereinafter.

FIG. 6 is a circuit diagram illustrating an exemplary configuration of a liquid crystal display device adapted to the spatial offset cancel operation, which is disclosed in Japanese Laid-Open Patent Application No. JP-A-Heisei 11-249624. The liquid crystal display device shown in FIG. 6 includes an interface board 100, a plurality of drain drivers 130, a plurality of gate drivers 140, and a liquid crystal display panel 101. The interface board 100 externally receives image data, a control signal clock CLK, a display timing signal, a horizontal synchronizing signal Hsync, and a vertical synchronizing signal Vsync. The interface board 100 includes a display controller 110 and a power supply circuit 120. The display controller feeds control signals to the drain drivers 130 and the gate drivers 140, and also feeds image signals to the drain drivers 130. The power supply circuit 120 includes a positive voltage generator 121, a negative voltage generator 122, a common electrode voltage generator 123, and a gate electrode voltage generator 124. The positive voltage generator 121 feeds positive voltages to the drain drivers 130. Further, the negative voltage generator 122 feeds negative voltages the drain drivers 130. The common electrode voltage generator 123 generates a common electrode voltage V_{COM} and supplies the common electrode voltage V_{COM} to the common electrode. The gate electrode voltage generator 124 feeds a predetermined power supply voltage to the gate drivers 140. The drain drivers 130 are connected to the drain lines (or signal lines) of the liquid crystal display panel. Further, the gate drivers 140 are connected to gate lines (or scan lines) of the liquid crystal display panel 101.

FIG. 7 is a timing chart illustrating exemplary signal transitions in the spatial offset cancel operation of the liquid crystal display device shown in FIG. 6. The display controller 110, which incorporates frequency dividing circuits and logic circuits, generates a CHOPA signal and a CHOPB signal, which are used to control operational amplifiers within the drain drivers 130. The CHOPB signal is an inverted signal of the CHOPA signal.

FIG. 8 is a circuit diagram of an exemplary configuration of operational amplifiers integrated within the drain drivers 130. In FIG. 8, the numerals “A” denote transistor switches which are turned on in response to the activation of the CHOPA signal, and the numerals “B” denote transistor switches which are turned on in response to the activation of the CHOPB signal. The operational amplifier shown in FIG. 8 is adapted to switch input signals inputted to the inverting input INM and to the non-inverting input INP at regular intervals in response to the CHOPA and CHOPB signals shown in FIG. 7.

In the liquid crystal display device shown in FIG. 6, the influences of the offset voltages of the operational amplifiers upon the brightnesses of the sub-pixels are opposite between adjacent two sub-pixels connected to the same drain or gate line. This effectively suppresses the deterioration of the picture quality caused by to the voltage offset of the operational amplifiers, achieving a high picture quality can be achieved as the entire screen.

It should be noted that, in a commonly-used liquid crystal display device adapted to the spatial offset cancel operation, each pixel incorporates three sub-pixels arranged in the scan line direction and drive voltages of the same polarity are simultaneously applied to the three sub-pixels of each pixel.

Although the three conventional techniques described above achieve power consumption reduction, picture quality improvement and manufacture cost reduction, the use of all the three conventional techniques may cause striped color unevenness when a checkered pattern is displayed on the liquid crystal display panel.

A detailed description is given of the striped color unevenness in displaying a checkered pattern. A checkered pattern is a pattern in which pixels of two different colors are arranged alternately in a grid-like form. For two pixels vertically or horizontally adjacent to each other, one is in a first color, and the other is in a second color. It is well known in the art that human eyes perceive such a checkered pattern as a region with a single color, when the pixels of the liquid crystal display panel are sufficiently small. Such optical illusion effect is actively utilized as one of the techniques in the computer graphics. This technique is extremely effective for a case where the number of allowed colors is restricted because of irreversible compression of image data or some other reasons. The checkered pattern is often used in images of JPEG and GIF, which are major image compression standards. Therefore, occurrence of striped color unevenness in displaying a checkered pattern is one of the major factors which cause deterioration in the picture quality.

In the following, a description is given of the mechanism of occurrence of the striped color unevenness in displaying a checkered pattern.

The problem of the striped color unevenness caused by the variations in the offset voltages of operational amplifiers within the source driver also applies the case where a checkered pattern is displayed. In detail, every other pixel suffers from undesired shift in the color tone due to the variations in the offset voltages. That is, every other pixel exhibiting the color tone shift is separated by a pixel of a different color. Even in such case, human eyes perceive the regularly-arranged every other pixel exhibiting the color tone shift as a straight segment. This results in the deterioration in the picture quality caused by the striped color unevenness.

Empirically, it is known in the art that human eyes perceives individual two pixels spaced from one another when the two pixels are separated by two or more pixels of a different color; in such case, the displayed image is free from striped color unevenness.

FIGS. 9A and 9B show an exemplary configuration of an operational amplifier incorporating an offset cancel circuit. The operational amplifier 150 has an output OUT, an inverting input INM, and a non-inverting input INP. The output of the operational amplifier 150 is directly connected to the output terminal OUT. The non-inverting input INP of the operational amplifier 150 is connected to the input terminal IN through a switch 151, and also connected to the output terminal OUT through a switch 154. The inverting input INM is connected to the input terminal IN through a switch 153, and also connected to the output terminal OUT through a switch 152. The switches 151 and 152 are both controlled in response to the CHOPA signal, and the switches 153 and 154 are both controlled in response to the CHOPB signal. It should be noted that, when one of the CHOPA and CHOPB signals is set high, the other is set low.

More specifically, when the CHOPA signal is set high, the CHOPB signal is set low. In such state, the offset polarity is defined as the state “A”, hereinafter. FIG. 9A shows the configuration of the offset cancel circuit for the case where the offset polarity is placed in the state “A”. In the state “A”, the switches 151 and 152 are turned on, and the switches 153 and 154 are turned off. As a result, the input terminal IN is connected to the non-inverting input INP, and the output terminal OUT is connected to the inverting input INM.

On the other hand, when the CHOPB signal is set high, the CHOPA signal is set low. In such state, the offset polarity is defined as the state “B”, hereinafter. FIG. 9B shows the configuration of the offset cancel circuit for the case where the offset polarity is placed in the state “B”. In the state “B”, the switches 153 and 154 are turned on, and the switches 151 and 152 are turned off. As a result, the input terminal IN is connected to the non-inverting input INM, and the output terminal OUT is connected to the inverting input INP.

In this manner, the offset cancel circuit shown in FIGS. 9A and 9B offers the offset cancelling of the operational amplifiers through switching the connections of the switches 151 to 154.

FIG. 10 is a time chart illustrating a typical operation of a liquid crystal display device adapted to the spatial offset cancel operation. The cycle period of the horizontal sync signal Hsync is identical to the time interval of the scan line switching. The CHOPA signal is kept at the high state over three periods of the horizontal sync signal Hsync, while the CHOPB signal is kept at the low state. In such case, the offset polarity is defined as the state “AAA”, hereinafter. The three periods of the horizontal synchronizing signal correspond to three R, G and B sub-pixels within each pixel. Over the next three periods, the CHOPB signal is set high, and the CHOPA signal is set low. In such state, the offset polarity is defined as the state “BBB”, hereinafter. In general, the offset cancel operation for the three sub-pixels within each pixel is controlled with the same offset polarity.

In the following, a discussion is given of a case where the offset cancel operation involves switching the CHOPA and CHOPB signals at the timings shown in FIG. 10. When all the pixels in a target area are set to the same color (such as, white, black, or the like), the striped color unevenness is not observed. This is because the offset cancel operation is effectively implemented in each frame.

In displaying a checkered pattern on a liquid crystal display panel with the triple gate arrangement, undesirable striped color unevenness is observed as discussed in the following. FIGS. 11A and 11B are drawings for explaining the striped color unevenness caused when a checkered pattern is displayed on a liquid crystal display panel with the triple gate arrangement, in which sub-pixels are vertically arranged in each pixel. In detail, FIG. 11A shows the primitive colors of the respective sub-pixels and the offset polarity states for the respective scan lines. FIG. 11B shows brightnesses of the respective sub-pixels and the offset polarity states for the respective scan lines when the checkered pattern is displayed. The checkered pattern is assumed to be comprised of white and gray pixels alternately arranged in the vertical and horizontal directions. In FIG. 11B, the sub-pixels within the white pixels are indicated by single-line boxes, while the subpixels within the gray pixels are indicated by double-line boxes.

FIGS. 12 and 13 schematically illustrate an example of the offset cancel operation. In the example of FIGS. 12 and 13, the operational amplifiers connected to the signal lines S3 and S6 suffer from particularly large voltage offsets. A white and gray checkered pattern is displayed in an area in which 48 pixels are arranged at respective intersections of scan lines G1 to G24 and signal lines S3 to S6. As is the case of FIG. 11B, white pixels are indicated by single-line boxes and gray pixels are indicated by double-line boxes. Further, double-line boxes with thick lines indicate pixels which suffer from particularly large offset voltages. The scan lines marked with the symbols “A” and “B” on the left side of FIG. 12 indicates the scan lines connected to the sub-pixels for which the offset polarity is set to the state “A” and “B”, respectively. The symbols “AAA” and “BBB” in FIGS. 12 and 13 indicate that the offset cancel states of the corresponding pixels are set to the state “AAA” and “BBB”, respectively. Although each pixel includes three sub-pixels in the example of FIGS. 12 and 13, the number of the sub-pixels within each pixel is not limited to three, as will be described later.

In the following, a discussion is given of the four gray pixels connected to the signal line S3, which experience large offset voltages. The offset polarities for the three sub-pixels of these four gray pixels are all set to the state “BBB”. This results in that the offset cancel operation does not work effectively for the sub-pixels within the four gray pixels of interest. As a result, the color of the gray four pixels becomes slightly different from the colors of the other neighboring gray pixels, and the difference in the colors is visually perceived as striped color unevenness.

A similar discussion applies to the four gray pixels connected to the signal line S6, which experience large offset voltages. The offset polarities for the three sub-pixels of the respective four pixels are all set to the state “AAA”. This results in that the offset cancel operation does not work effectively for the sub-pixels within the four gray pixels of interest, causing the striped color unevenness.

### SUMMARY

In an aspect of the present invention, a method is provided for driving a liquid crystal display panel in which each pixel includes a plurality of sub-pixels arranged in a specific direction, the method including feeding drive voltages to sub-pixels within the liquid crystal display panel by using operational amplifiers. The polarities of the drive voltages fed to each of the sub-pixels are inverted between two adjacent frame periods. The offset polarities of the operational amplifiers are inverted for every a predetermined number of successive sub-pixels. The number of the sub-pixels within each pixel is coprime to the predetermined number of successive sub-pixels.

In another aspect of the present invention, a liquid crystal display device is provided with a liquid crystal display panel provided with a plurality of pixels arranged in rows and columns, each of the pixels including a number of sub-pixels arranged in a specific direction; a display panel drive circuit including operational amplifiers which feeds drive voltages to sub-pixels within the liquid crystal display panel and an offset cancel control circuit controlling polarities of offset voltages of the operational amplifiers. The display panel drive circuit generates the drive voltages so that polarities of the drive voltages fed to each of the sub-pixels are inverted between two adjacent frame periods. The offset cancel control circuit controls the polarities of the offset voltages of the operational amplifiers so that the offset polarities of the operational amplifiers are inverted for every a predetermined number of successive sub-pixels. The number of the sub-pixels within each pixel is coprime to the predetermined number of successive sub-pixels.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows an exemplary arrangement of sub-pixels of a conventional liquid crystal display panel with the triple gate arrangement;

FIG. 2 shows a circuit diagram of an exemplary configuration of a single pixel of the conventional liquid crystal panel with the triple gate arrangement;

FIG. 3 is a block diagram showing an exemplary configuration of a conventional liquid crystal display device in which a source and gate driver are monolithically integrated within a single semiconductor chip for driving a liquid crystal display panel;

FIG. 4 schematically shows a dot inversion drive technique;

FIG. 5 schematically shows a column inversion drive technique;

FIG. 6 is a circuit diagram illustrating an exemplary configuration of a conventional liquid crystal display device adapted to the offset cancel operation;

FIG. 7 is a timing chart illustrating a spatial offset cancel operation according to a conventional technique;

FIG. 8 is a circuit diagram of an exemplary configuration of a conventional operational amplifier adapted to the spatial offset cancel operation;

FIGS. 9A and 9B show a typical configuration of an operational amplifier incorporating an offset cancel circuit;

FIG. 10 is a time chart illustrating an exemplary operation of a conventional liquid crystal display device;

FIGS. 11A and 11B are drawings illustrating striped color unevenness observed when a checkered pattern is displayed in a liquid crystal display device with the triple gate arrangement;

FIGS. 12 and 13 are drawings explaining an exemplary offset cancel operation;

FIG. 14 shows an example of a circuit diagram of a liquid crystal display panel and a source driver in one embodiment of the present invention;

FIG. 15 is a time chart illustrating the operation of the liquid crystal display device in one embodiment of the present invention;

FIG. 16 is a drawing illustrating the effect of suppressing the striped color unevenness in displaying a checkered pattern in one embodiment of the present invention; and

FIG. 17 is a drawing illustrating an example of offset polarity states of respective pixels in the liquid crystal display panel in one embodiment of the present invention.

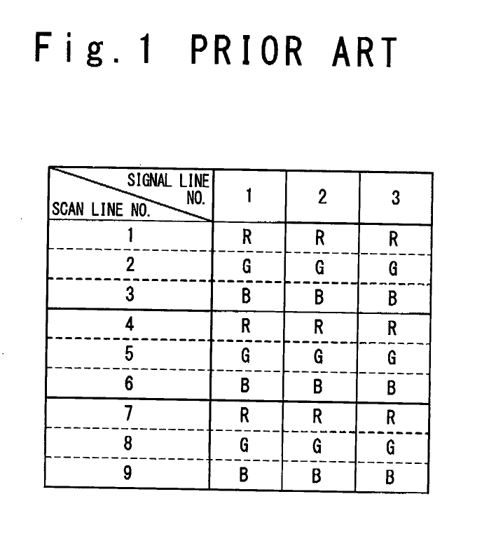

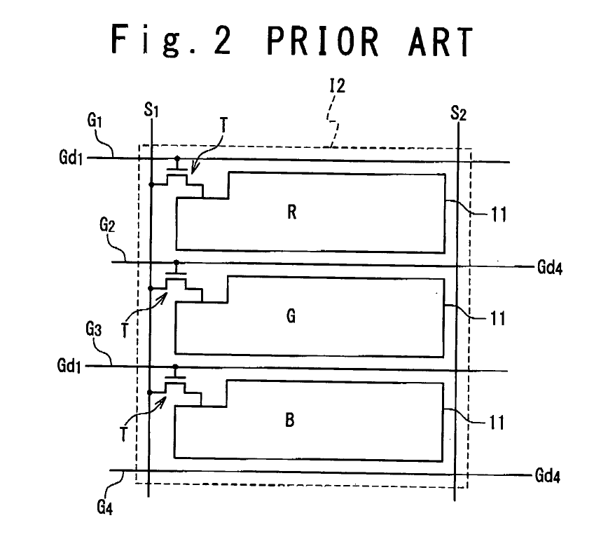

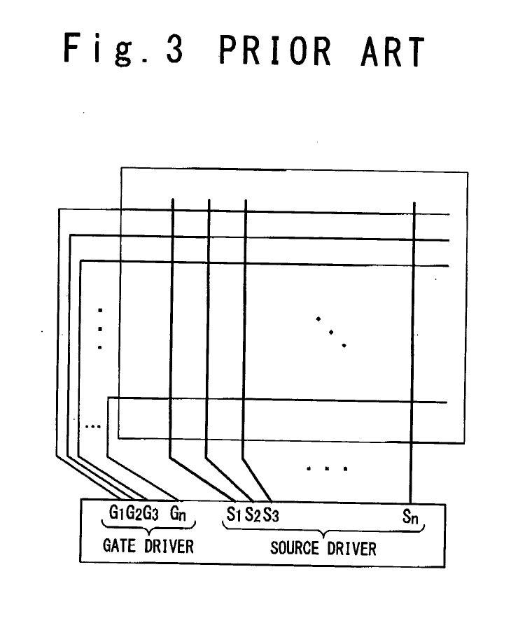

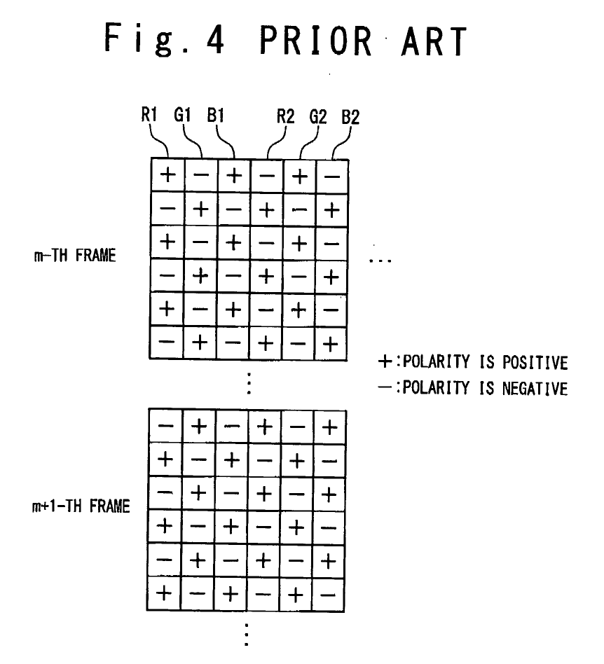

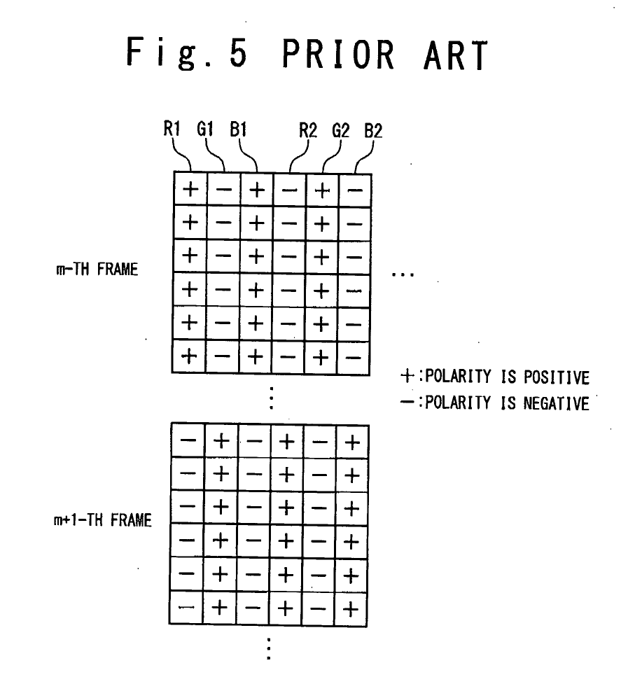

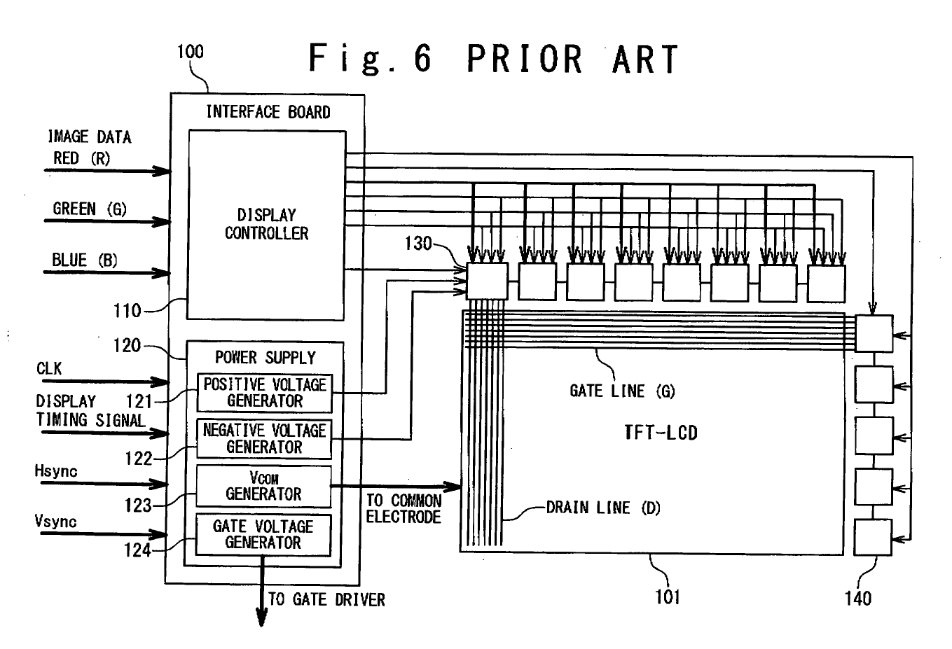

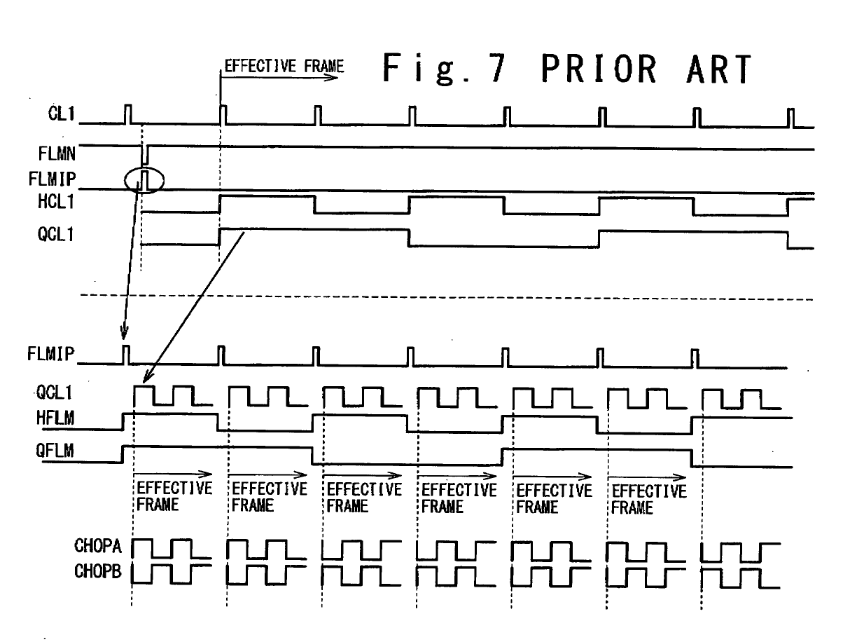

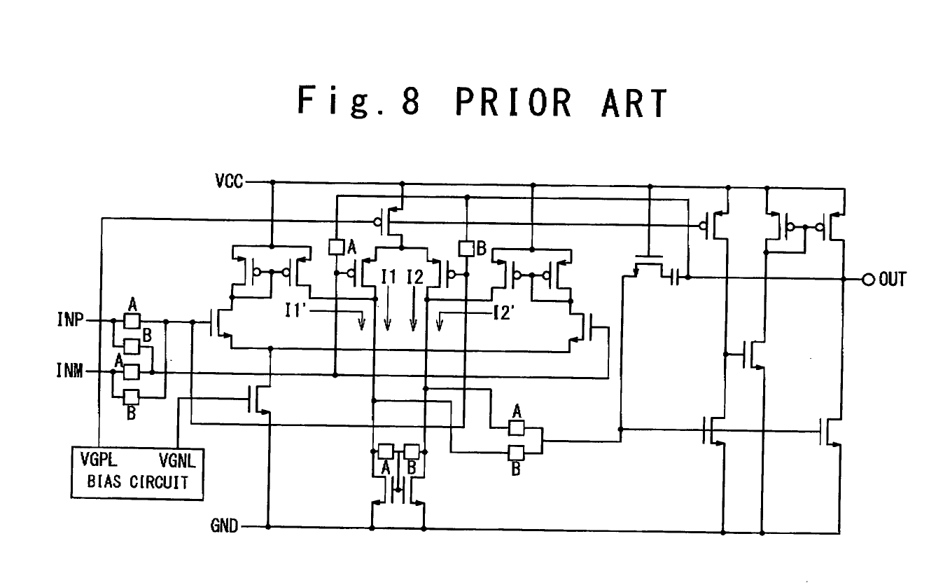

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

In the following, descriptions will be given of implementations in which each pixel includes three sub-pixels associated to red (R), green (G), and blue (B), respectively, as in the case of most popular color liquid crystal display devices. It should be noted, however, that the present invention is also applicable to liquid crystal display devices in which each pixel includes a different number of sub-pixels, as is understood from the principle of the present invention. Although embodiments given in the following are directed to a liquid crystal display device with the triple gate arrangement, in which three sub-pixels in each pixel are arranged in the signal line direction, the skilled person would appreciate that the present invention is also applicable to a liquid crystal display device which adopts a sub-pixel arrangement other than the triple gate arrangement, such as a sub-pixel arrangement in which three sub-pixels in each pixel are arranged in the scan line direction.

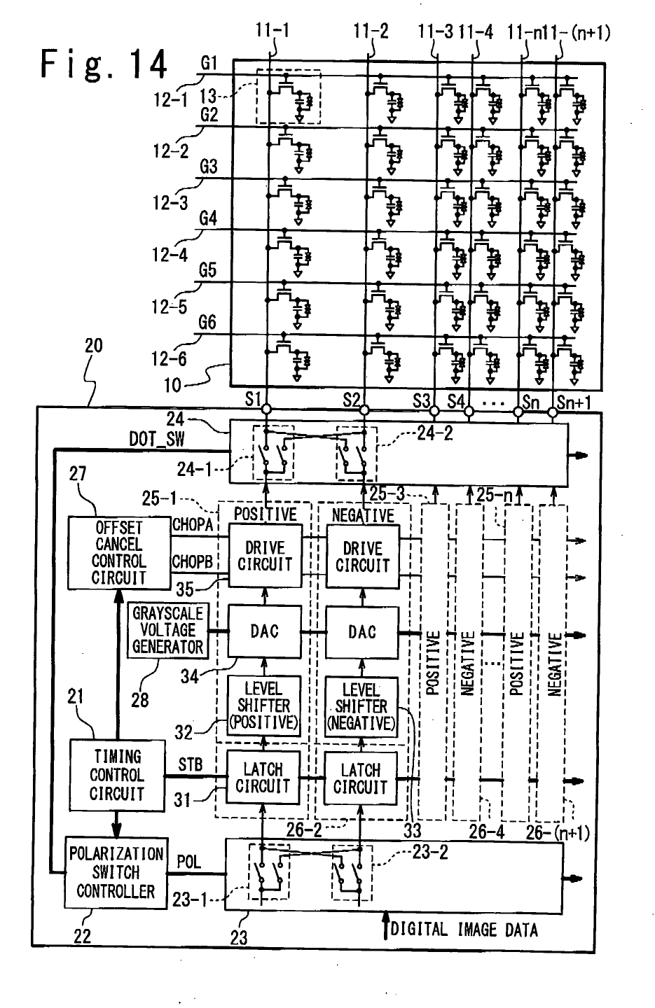

FIG. 14 is a circuit diagram illustrating an exemplary configuration of a liquid crystal display device in one embodiment of the present invention. The liquid crystal display device of this embodiment is provided with a liquid crystal display panel 10 and an LCD panel driver 20. The LCD panel driver 20 includes: a timing control circuit 21; a polarity changeover switch control circuit 22; an input-side polarity changeover switch circuitry 23; an output-side polarity changeover switch circuitry 24; a plurality of positive source driver circuits 25-i; a plurality of negative source driver circuits 26-i; an offset cancel control circuit 27; and a grayscale voltage generator 28. The positive source driver circuits 25-i each include a latch circuit 31, a positive level shifter circuit 32, a DAC (Digital Analog Converter) circuit 34, and a driver circuit 35. Correspondingly, the negative source driver circuits 26-i each include a latch circuit 31, a negative level shifter circuit 33, a DAC circuit 34, and a driver circuit 35.

The liquid crystal display panel 10 is provided with signal lines (or source lines) 11-i; scan lines (or gate lines) 12-j; and liquid crystal cells 13. Each single liquid crystal cell 13 is connected to one single signal line 11-i and one scan line 12-j, which corresponds to a sub-pixel 14.

The LCD panel driver 20 operates as follows: The LCD panel driver 20 externally receives digital image data which are indicative of grayscale levels of the respective sub-pixels 14. The digital image data are sent to the corresponding positive source driver circuits 25-i or to the corresponding negative-electrode source drivers 26-i through the input-side polarity changeover switch circuitry 23. The source driver circuits 25-i and 26-i generate drive voltages corresponding to the digital image data for the corresponding sub-pixels 14. The generated drive voltages are sent to the corresponding signal lines 11-i through the output-side polarity changeover switch circuitry 24.

The input-side polarity changeover switch circuitry 23 and the output-side polarity changeover switch circuitry 24 are controlled by the polarity changeover switch control circuit 22. More specifically, the i-th positive-electrode polarity changeover switch 23-i and the (i+1)-th negative-electrode polarity changeover switch 23-(i+1) are paired to allow the positive electrode source driver circuit 25-i and the negative electrode source driver circuit 26-(i+1) to alternately develop the drive voltages in response to the digital image data associated with the i-th signal line 11-i and the (i+1)-th signal line 11-(i+1).

Such architecture is directed to perform the dot inversion drive or the column inversion drive described above. More specifically, in order to achieve the dot inversion drive, the input-side and output-side polarity changeover switch circuitries 23 and 24 operate to switch the polarities of the drive voltages fed to the signal lines 11 in units of the scan lines. In order to achieve the dot inversion drive, on the other hand, the input-side and output-side polarity changeover switch circuitries 23 and 24 operate to switch the polarities of the drive voltages fed to the signal lines 11 in units of the frame periods.

The positive-electrode source driver circuit 25-i operates as follows: The digital image data received from the input-side polarity changeover switch 23-i are sent first to the latch circuit 31.

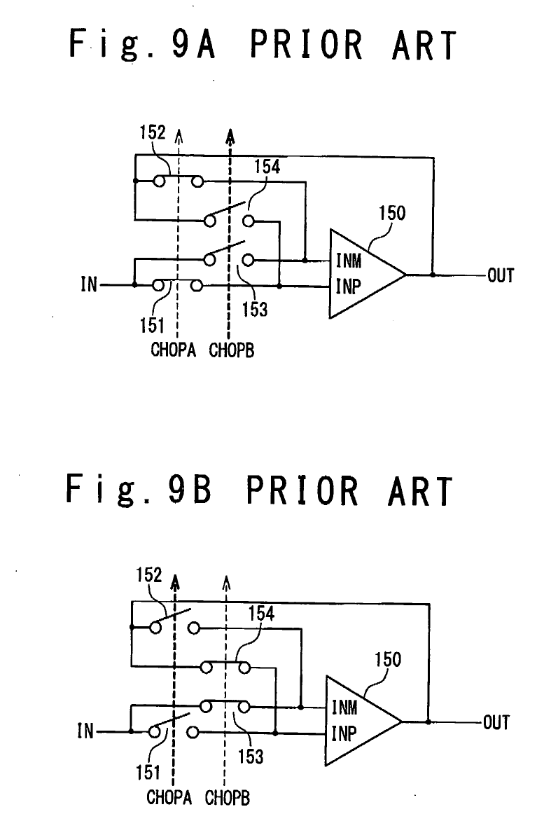

The latch circuit 31 temporarily stores the received digital image data, and transfers the digital image data to the positive level shifter 32. The timings of the digital image data transfer by the latch circuit 31 is mainly controlled by the timing control circuit 21. The positive level shifter 32 provides the signal level shifting for the output signal of the latch circuit 31 to achieve signal level matching between the latch circuit 31 and the DAC circuit 34. The DAC circuit 34 receives the digital image data from the latch circuit 31 through the positive level shifter 32 and converts the digital image data received into the corresponding grayscale voltage. More specifically, the DAC circuit 34 receives a set of grayscale voltages from the grayscale voltage generator 28, and selects one of the grayscale voltages corresponding to the value of the digital image data. The grayscale voltage generated by the DAC circuit 34 is fed to the driver circuit 35. The driver circuit 35 drives the signal line 11 connected thereto to the voltage level identical to the level of the grayscale voltage received from the DAC circuit 34. The driver circuit 35 includes an operational amplifier shown in FIGS. 9A and 9B, and the operation of this operational amplifier is controlled by a pair of control signals: CHOPA and CHOPB signals as described above. The CHOPA and CHOPB signals are fed from the offset cancel control circuit 27 to the driver circuit 35. The polarity of the offset voltage of the operational amplifier within the driver circuit 35 is switched in response to the CHOPA and CHOPB signals. Further, the timing control circuit 21 controls the polarity changeover switch control circuit 22 and the offset cancel control circuit 27, in addition to the above-described latch circuit 31. The polarity changeover switch control circuit 22 controls the input-side polarity changeover switch circuitry 23 and the output-side polarity changeover switch circuitry 24.

The operation of the negative source driver circuits 26-i is similar to that of the positive source driver circuits 25-i.

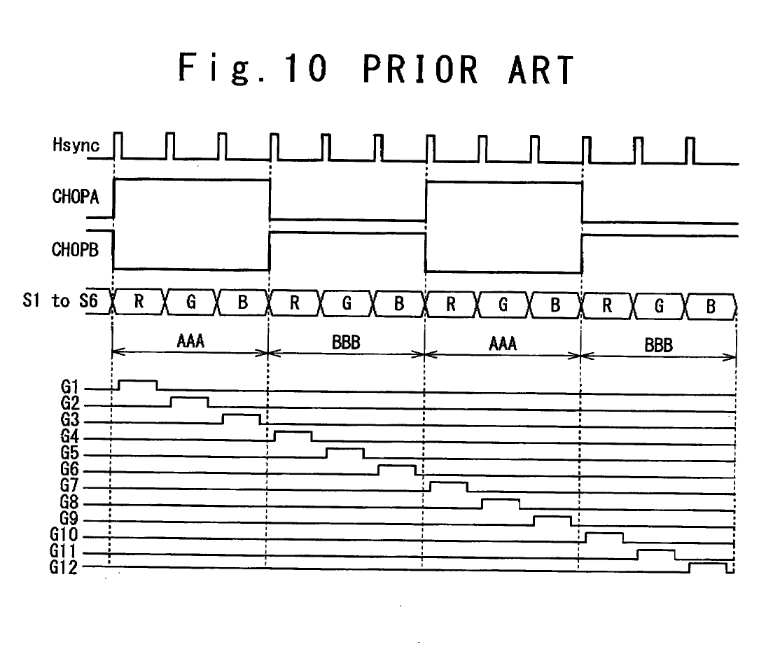

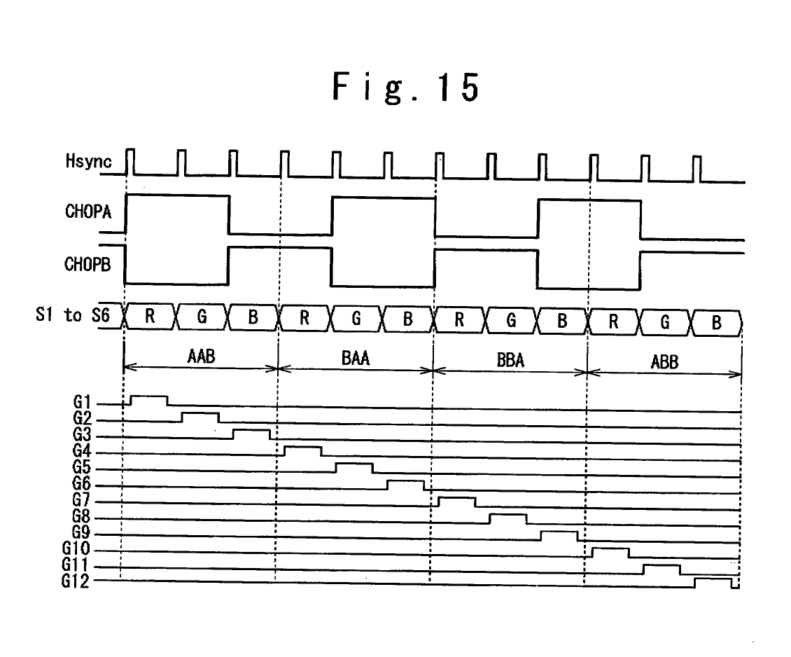

The main feature of the operation of the LCD driver 20 of this embodiment is the control of the offset voltages of the operational amplifiers within the driver circuits 35. FIG. 15 is a time chart illustrating signal transitions within the liquid crystal display panel 10 and the LCD driver circuit 20 in this embodiment. Attention should be paid to the signal transitions of the CHOPA and CHOPB signals, which are used to control the offset polarities of the operational amplifiers within the driver circuits 35. In the conventional technique shown in FIG. 10, the CHOPA and CHOPB signals are inverted for every three sub-pixels arranged in the horizontal direction; the cycle period of the CHOPA and CHOPB signals in the offset cancel operation are six horizontal periods in the operation shown in FIG. 10. In this embodiment, on the other hand, the CHOPA and CHOPB signals are inverted for every two sub-pixels, as shown in FIG. 15; the cycle period of the CHOPA and CHOPB signals in the offset cancel operation are four horizontal periods in this embodiment.

As a result, the offset polarity is switched once while the drive of the three sub-pixels within each pixel. The offset polarity state for a certain pixel is selected from the states “AAB”, “BAA”, “BBA”, and “ABB”, never set to the state “AAA” or “BBB” as in the conventional technique.

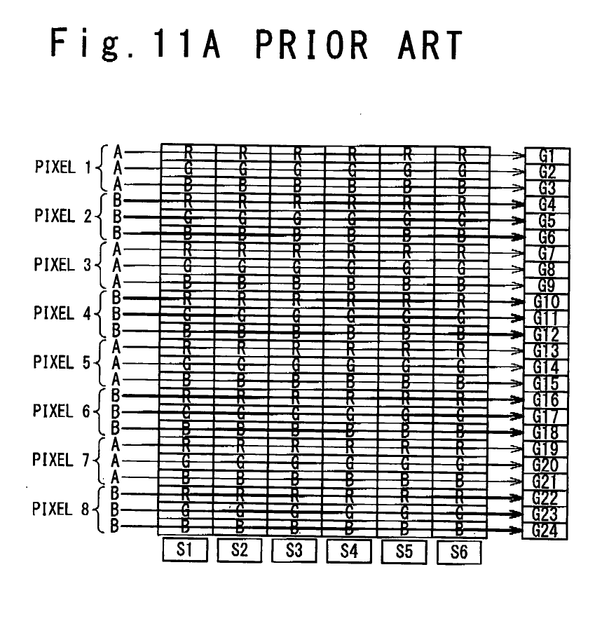

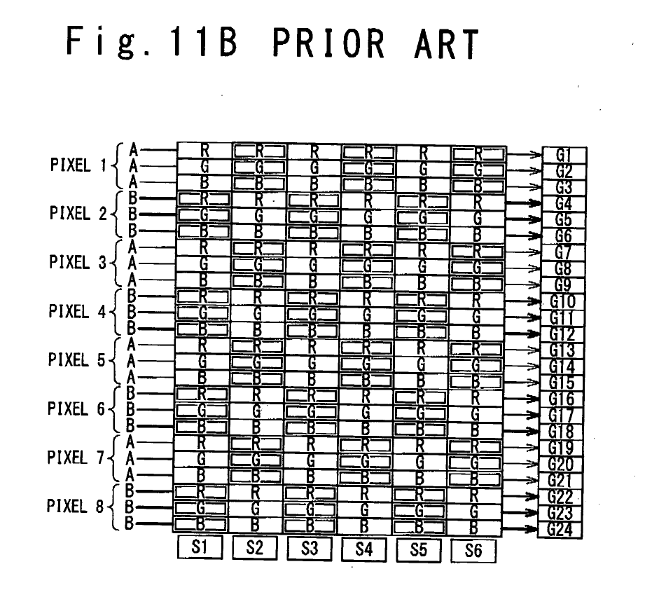

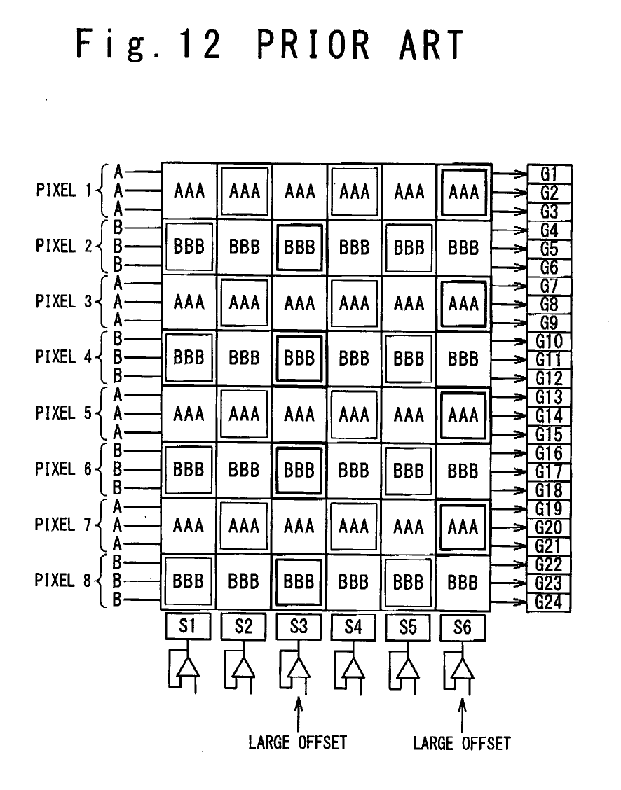

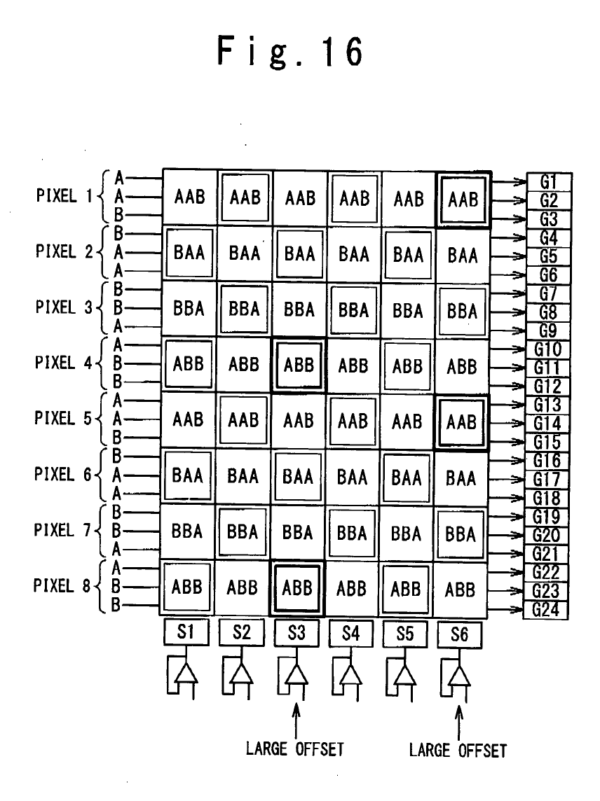

The offset cancel operation described above effectively avoids the problem of the striped color unevenness. FIG. 16 is a drawing for explaining the effect of the offset cancel operation for suppressing the striped color unevenness generated in displaying a checkered pattern on the liquid crystal display panel 10 in this embodiment. As described above referring to FIGS. 11A, 11B, 12, and 13, the conventional offset cancel operation is undesirably accompanied by the occurrence of the striped color unevenness when a checkered pattern is displayed on the liquid crystal display panel 10. For example, in FIG. 12, the four gray pixels in the state “BBB” connected to the signal line S3 connected to the operational amplifier suffering from the large voltage offset are positioned so that neighboring two of the four gray pixels are separated by a white pixel, and therefore the four gray pixels are perceived as striped color unevenness by human eyes. This is because the pixels of the same color are arranged in an alternate manner in displaying the checkered pattern.

On the other hand, the offset cancel operation of this embodiment involves switching the offset polarities for every two scan lines as shown in FIG. 16. This allows cancelling the offsets of the operational amplifiers with respect to the vertical direction. For example, the two pixels in the state “ABB” indicated by the double-line boxes with thick lines are the pixels of the same color connected to the signal line S3 which is connected to the operational amplifier with a large offset voltage. It should be noted that there is a pixel of the same color in the state “BAA” between the two pixels in the state “ABB”. That is, the two pixels in the state “ABB” are separated by a sufficient distance therebetween, so that human eyes do not perceive the two pixels in the state “ABB” as striped color unevenness.

As is understood from the principle of the present invention, the present invention is generally effective in the case where the number of sub-pixels provided within each pixel is coprime to the number of the series of sub-pixels driven with the same offset polarity in the offset cancel operation; those two numbers are a combination that satisfies the requirement that the greatest common divisor thereof is “1” and the least common multiple is equal to the product thereof. Satisfying this requirement allows providing a sufficient distance between the pixels experiencing the voltage offsets of the same offset polarity, and effectively suppresses the occurrence of striped color unevenness.

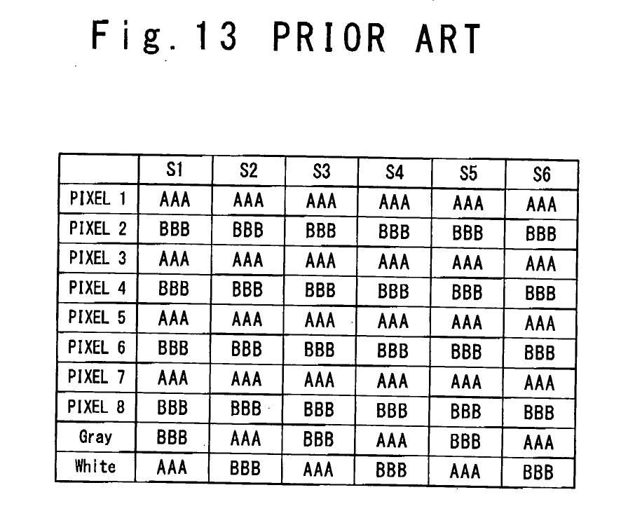

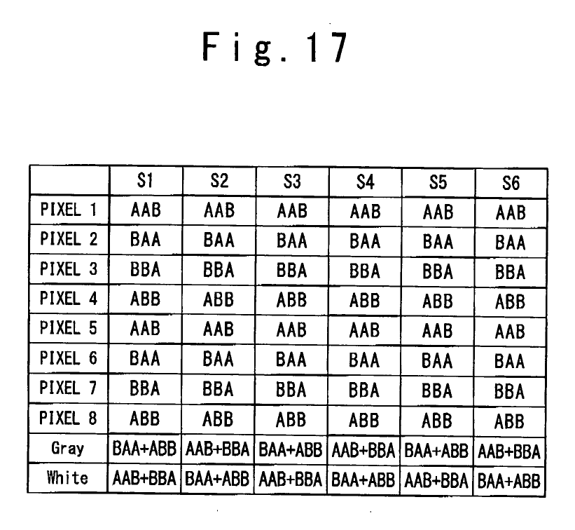

FIG. 17 is a drawing showing an example of the offset polarity states within the respective pixels in the liquid crystal display device of this embodiment. In the conventional technique shown in FIG. 13, there is only one allowed offset cancel state for one color in displaying in a checkered pattern. This undesirably invalidates the effectiveness the offset cancel operation. In the offset cancel operation of this embodiment, on the other hand, there are two allowed offset polarity states for one color. In addition, the two offset polarity states appear alternately with respect to the plurality of pixels connected to the same signal line. This allows the offset cancel operation to work effectively to overcome the striped color unevenness.

It is apparent that the present invention is not limited to the above embodiments, but may be modified and changed without departing from the scope of the invention. For example, a different circuit configuration may be used for achieving the offset cancel operation in accordance with the present invention.

What is claimed is:

1. A method of driving a liquid crystal display panel in which each pixel includes a plurality of sub-pixels arranged in a specific direction, comprising:
feeding drive voltages to sub-pixels within said liquid crystal display panel by using operational amplifiers,
wherein polarities of said drive voltages fed to each of said sub-pixels are inverted between two adjacent frame periods, and
wherein offset polarities of said operational amplifiers are inverted for every a predetermined number of successive sub-pixels,
wherein a number of said sub-pixels within each pixel is coprime to said predetermined number of successive sub-pixels.

2. The method according to claim 1, wherein said predetermined number of successive sub-pixels is less than said number of sub-pixels within each pixel.

3. The method according to claim 1, wherein said sub-pixels within each pixel is arranged in a direction in which signal lines are extended within said liquid crystal display panel.

4. The method according to claim 1, wherein drive voltages of opposite polarities are fed to adjacent two of said sub-pixels arranged in a direction in which scan lines are extended within said liquid crystal display panel.

5. The method according to claim 4, wherein drive voltages of opposite polarities are fed to adjacent two of said sub-pixels arranged in a direction in which signal lines are extended within said liquid crystal display panel.

6. The method according to claim 1, wherein said number of said sub-pixels within each pixel is three and said predetermined number of successive sub-pixels is two.

7. A liquid crystal display device comprising:
a liquid crystal display panel provided with a plurality of pixels arranged in rows and columns, each of said pixels including a number of sub-pixels arranged in a specific direction; and
a display panel drive circuit including operational amplifiers which feeds drive voltages to sub-pixels within said liquid crystal display panel, and an offset cancel control circuit controlling polarities of offset voltages of said operational amplifiers;
wherein said display panel drive circuit generates said drive voltages so that polarities of said drive voltages fed to each of said sub-pixels are inverted between two adjacent frame periods,
wherein said offset cancel control circuit controls said polarities of said offset voltages of said operational amplifiers so that said offset polarities of said operational amplifiers are inverted for every a predetermined number of successive sub-pixels, and
wherein a number of said sub-pixels within each pixel is coprime to said predetermined number of successive sub-pixels.

8. The liquid crystal display device according to claim 7, wherein said predetermined number of successive sub-pixels is less than said number of sub-pixels within each pixel.

9. The liquid crystal display device according to claim 7, wherein said sub-pixels within each pixel is arranged in a direction in which signal lines are extended within said liquid crystal display panel.

10. The liquid crystal display device according to claim 7, wherein drive voltages of opposite polarities are fed to adjacent two of said sub-pixels arranged in a direction in which scan lines are extended within said liquid crystal display panel.

11. The liquid crystal display device according to claim 10, wherein drive voltages of opposite polarities are fed to adjacent two of said sub-pixels arranged in a direction in which signal lines are extended within said liquid crystal display panel.

12. The liquid crystal display device according to claim 7, wherein said number of said sub-pixels within each pixel is three and said predetermined number of successive sub-pixels is two.

13. The liquid crystal display device according to claim 7, wherein said display panel drive circuit includes:
a plurality of pairs of positive and negative source driver circuits;
a polarity changeover switch circuitry connected to outputs of said positive and negative source driver circuits;
wherein said positive source driver circuit within each of said pairs generates a drive voltage of a positive polarity and said negative source driver circuit within each of said pairs generates a drive voltage of a negative polarity, and
wherein said polarity changeover switch circuitry connects each of signal lines within said liquid crystal display panel to selected one of positive and negative source driver circuits within corresponding one of said pairs of positive and negative source driver circuits.

14. The liquid crystal display device according to 13, wherein said positive and negative source driver circuits each include:
a latch circuit receiving digital image data;
a level shifter providing signal level shifting for an output signal of said latch circuit; and
a digital-analog converter converting said digital image data received from said latch circuit through said level shifter into a grayscale voltage corresponding to said digital image data, and feeding said grayscale voltage to associated one of said operational amplifiers,
wherein said display panel drive circuit further includes:
a timing control circuit controlling said latch circuit, said polarity changeover switch control circuit, and said offset cancel circuit; and
a grayscale voltage generator circuit generating a set of grayscale voltages from which said digital-analog converter selects one corresponding to said digital image data.

15. A liquid crystal display panel driver for driving a liquid crystal display panel provided with a plurality of pixels arranged in rows and columns, each of said pixels including a number of sub-pixels arranged in a specific direction, said driver comprising:
a display panel drive circuit including operational amplifiers which feeds drive voltages to sub-pixels within said liquid crystal display panel; and
an offset cancel control circuit controlling polarities of offset voltages of said operational amplifiers,
wherein said display panel drive circuit generates said driver voltages so that polarities of said drive voltages fed to each of said sub-pixels are inverted between two adjacent frame periods, and
wherein said offset cancel control circuit controls said polarities of offset voltages of said operational amplifiers so that said offset polarities of said operational amplifiers are inverted for every a predetermined number of successive sub-pixels,
wherein a number of said sub-pixels within each pixel is coprime to said predetermined number of successive sub-pixels.
